(19) United States
(12) Patent Application Publication
(10) Pub. No.: US 2019/0050796 A1
(43) Pub. Date: Feb. 14, 2019

(54) METHOD OF AUDITING COLD CHAIN DISTRIBUTION SYSTEMS

(71) Applicant: CARRIER CORPORATION, Farmington, CT (US)

(72) Inventors: Marc Beasley, Beverly, MA (US); Jeffrey Allen Leshuk, Davis, CA (US); Murat Yasar, West Hartford, CT (US); Mark E. Cywilko, Jamesville, NY (US)

(21) Appl. No.: 16/077,090

(22) PCT Filed: Feb. 8, 2017
(86) PCT No.: PCT/US2017/016928

§ 371 Date: Aug. 10, 2018

Related U.S. Application Data
(60) Provisional application No. 62/294,774, filed on Feb. 12, 2016.

(51) Int. Cl. G06Q 10/08; G06Q 50/00; G06Q 30/00

(52) U.S. Cl. CPC G06Q 10/0832; G06Q 30/018; G06Q 50/01

(57) ABSTRACT

A method for auditing a cold chain distribution system is provided. The method includes: collecting, using a receiver, at least one perishable good parameter from the cold chain distribution system; transmitting the at least one perishable good parameter to a computing device; comparing, using a standards matching model and the computing device, the at least one perishable good parameter to compliance criteria; and transmitting at least one compliance criteria comparison output from the computing device to a database.

### BACKGROUND OF THE DISCLOSURE

The embodiments disclosed herein generally relate to cold chain distribution systems, and more specifically to a method and an apparatus for auditing cold chain distribution systems.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Government regulations, customer requirements, and even company standards each set criteria for the handling of perishable goods that cold chain distribution systems must satisfy. Providing audits of these criteria are often labor intensive, time-consuming, and inefficient.

### BRIEF DESCRIPTION OF THE DISCLOSURE

According to one embodiment, a method of auditing a cold chain distribution system, the method is provided. The method includes collecting, using a receiver, at least one perishable good parameter from the cold chain distribution system. The method also includes transmitting the at least one perishable good parameter to a computing device. The method further includes comparing, using a standards matching model and the computing device, the at least one perishable good parameter to compliance criteria. The method yet further includes transmitting at least one compliance criteria comparison output from the computing device to a database.

In addition to one or more of the features described above, or as an alternative, further embodiments may include wherein collecting further comprises monitoring, using at least one sensor, at least one perishable good parameter.

In addition to one or more of the features described above, or as an alternative, further embodiments may include wherein collecting further comprises receiving, at least one perishable good parameter, from at least one supplier database.

In addition to one or more of the features described above, or as an alternative, further embodiments may include wherein collecting further comprises receiving, at least one perishable good parameter, from at least one supplier database.

In addition to one or more of the features described above, or as an alternative, further embodiments may include manually entering at least one perishable good parameter into the receiver.

In addition to one or more of the features described above, or as an alternative, further embodiments may include collecting social media data; and comparing the social media data to the at least one compliance criteria comparison output.

According to another embodiment, an apparatus for auditing a cold chain distribution system includes a computing device configured to compare at least one perishable good parameter to compliance criteria using a standards matching model. Also included is a receiver in operative communication with the computing device, wherein the receiver is configured to receive at least one perishable good parameter from the cold chain distribution system and transmit the at least one perishable good parameter to the computing device. Further included is a database in operative communication with the computing device, wherein the database is configured to receive and store at least one compliance criteria comparison output from the computing device.

In addition to one or more of the features described above, or as an alternative, further embodiments may include at least one sensor in operative communication with the receiver, wherein the at least one sensor is configured to sense at least one perishable good parameter and communicate the at least one perishable good parameter to the receiver.

In addition to one or more of the features described above, or as an alternative, further embodiments may include at least one supplier database in operative communication with the receiver, wherein the at least one supplier database is configured communicate the at least one perishable good parameter to the receiver.

In addition to one or more of the features described above, or as an alternative, further embodiments may include at least one supplier database in operative communication with the receiver, wherein the at least one supplier database is configured communicate the at least one perishable good parameter to the receiver.

In addition to one or more of the features described above, or as an alternative, further embodiments may include a manual entry of at least one perishable good parameter into the receiver.

In addition to one or more of the features described above, or as an alternative, further embodiments may include a social media tracker in operative communication with the database, wherein the social media tracker is configured to collect social media data and compare the social media data to the at least one compliance criteria comparison output.

Other aspects, features, and techniques of the invention will become more apparent from the following description taken in conjunction with the drawings.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of an apparatus for auditing a cold chain distribution system; and

FIG. 2 illustrates a schematic view of a method of auditing a cold chain distribution system.

### DETAILED DESCRIPTION OF THE DISCLOSURE

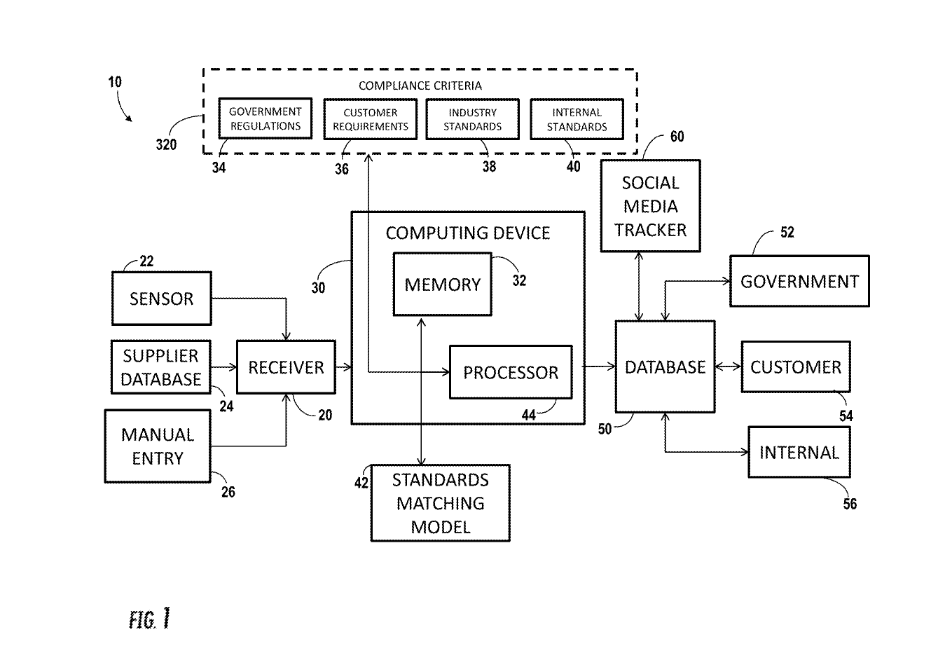

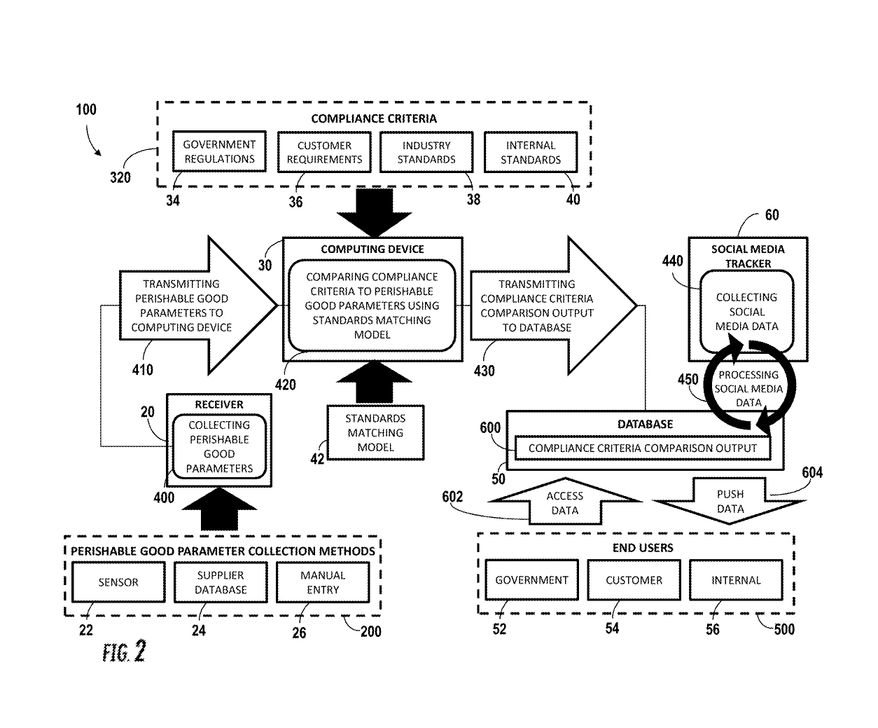

Referring now to the drawings, FIG. 1 illustrates a schematic view of an apparatus 10 for auditing a cold chain distribution system. FIG. 2 illustrates a schematic view of a method 100 of auditing a cold chain distribution system. In the illustrated embodiment, the apparatus 10 includes a computing device 30, a receiver 20 in operative communication with the computing device 30, and a database 50 in operative communication with the computing device 30. The computing device 30 is configured to compare at least one perishable good parameter to compliance criteria 320 using a standards matching model 42. The standards matching model 42 is an algorithm that correlates the perishable good parameters to the compliance criteria 320 to determine if the compliance criteria 320 is being satisfied. In various embodiments, the compliance criteria 320 may be stored directly within the memory 32 of the computing device 30 or it may be sent to the computing device 30 via a wireless computer network, such as, for example, a wide area network or the internet. The receiver 20 is configured to receive at least one perishable good parameter from the cold chain distribution system and transmit the at least one perishable good parameter to the computing device 30. In a further embodiment, the receiver 20 may be an electronic computing device including a microprocessor and an associated memory bank. The database 50 is configured to receive and store at least one compliance criteria comparison output 600 from the computing device 30.

In the illustrated embodiment, the apparatus 10 may further include a variety of perishable good parameter collection methods 200 including but not limited to at least one sensor 22, at least one supplier database 24, and manual entry 26. The at least one sensor 22 is in operative communication with the receiver 20 and is configured to sense at least one perishable good parameter then communicate the at least one perishable good parameter to the receiver 20. In further embodiments, the at least one sensor 22 may sense perishable good parameters including but not limited to temperature, pressure, humidity, carbon dioxide, ethylene, ozone, vibrations, light exposure, duration of travel and Global Positioning System (GPS) location. In further embodiments, the at least one sensor 22 may also be able to automatically sense the type perishable goods and attributes of the perishable goods within the cold chain distribution system. The attributes of the perishable goods may include but are not limited to weight, size, sugar content, maturity, grade, ripeness, labeling, and packaging. The at least one sensor 22 may be able to distinguish the type of perishable goods and detect perishable good attributes via many sensing techniques including but not limited to optical, odor, soundwave, infrared, and via a physical probe. Additionally, the at least one supplier database 24 is in operative communication with the receiver 20 and is configured to communicate the at least one perishable good parameter to the receiver 20. The at least one supplier database 24 may include but is not limited to such information as to how the perishable good was cultivated and handled prior to entering the cold chain distribution system. Further, at least one perishable good parameter may be entered manually as a manual entry 26 into the receiver 20. While the apparatus 10 for auditing a cold chain distribution system strives for simplification through automation with at least one sensor 22 and linking to at least one supplier database 24, often times the need for manual entry 26 of data is unavoidable.

In a further embodiment, the computing device 30 may include a processor 44 and an associated memory 32. In a further embodiment, the processor 44 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. In another further embodiment, the memory 32 may be but is not limited to a random access memory (RAM), read only memory (ROM), or other electronic, optical, magnetic or any other computer readable medium. The standards matching model 42 may be stored within the memory 32 of the computing device 30 or the standards matching model 32 may be stored at a distant location and connected to the computing device 30 via a wireless computer network, such as, for example, a wide area network or the internet. Likewise, in a further embodiment, compliance criteria 320 may be stored within the memory 32 of the computing device 30 or at a distant location and connected to the computing device 30 via a wireless computer network, such as, for example, a wide area network and the internet. The compliance criteria 320 may include but is not limited to government regulations 34, customer requirements 36, industry standards 38, and internal standards 40. Internal standards 40 meaning standards that are internal to the company in control of the cold chain distribution system. Compliance criteria 320 place various requirements on the perishable goods throughout the cold chain distribution system including the handling of the perishable goods, the condition of the perishable goods and the attributes of the perishable goods. Compliance criteria 320 may include handling requirements such as, for example, requirements regarding temperature, pressure, humidity, carbon dioxide, ethylene, ozone, vibrations, light exposure, travel duration, packaging, approved vendors and embargoed countries. For instance, strawberries may need to be protected from excessive shock and kept at 34° F. during transport. Compliance criteria 320 may further include perishable conditions and attributes such as, for example, weight, size, sugar content, maturity, grade, ripeness, labeling, and packaging. For instance, strawberries may need to be in 1 pound clamshells, be a certain weight or grade, be organic, and have certain packaging or labels on the clamshells. The standards matching model 42 will utilize the compliance criteria 320 and the perishable good parameters and produce a compliance criteria output 600.

In the illustrated embodiment, the apparatus 10 includes a database 50 to store the compliance criteria output 600. In a further embodiment, the database 50 may be a memory bank, such as, for example random access memory (RAM), read only memory (ROM), or other electronic, optical, magnetic or any other computer readable medium. Whereas in another further embodiment, the database 50 may be an electronic computing device including a microprocessor and an associated memory bank. The database 50 may be directly connected to the computing device 30 or connected via a wireless computer network, such as, for example, a wide area network or the internet. Perishable goods not meeting the compliance criteria 320 may be flagged in the database 50. In further embodiments, end uses 500 may be able to access data 602 within the database 50 or the database 50 may push data 604 out to the end users 500. In yet further embodiments, end users 500 may include but are not limited to, customer 54, government 52, and internal 56.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. End users 500 set compliance criteria 320 for the handling of perishable goods that cold chain distribution systems must satisfy. The apparatus 10 in FIG. 1 and method 100 in FIG. 2 aid in providing easily accessible compliance criteria comparison output 600 data to allow audit decisions to be carried out quickly and efficiently.

In the illustrated embodiment, the apparatus 10 may also include a social media tracker 60 in operative communication with the database 50. In a further embodiment the social media tracker 60 may be an electronic computing device including a microprocessor and an associated memory. The social media tracker 60 is configured to monitor social media data for posts and searches regarding topics that might indicate an anomaly in a perishable good such as, for example food safety and food quality. For instance, posts such as, for example “the bananas looked gross,” “I don't know what I ate, but I feel sick today,” and “I love Farmer Joe's Berries!” The social media post text, tags, and meta data indicating the location of the post, the time/date of the post, the language of the post and the user name may help the social media tracker 60 narrow down the local store where the perishable good containing an anomaly may have been purchased. The social media tracker 60 is configured to compare the social media data with compliance criteria output 600. This comparison is referred to as processing social media at 450, wherein the social media data is aggregated and then analyzed for meaningful or actionable patterns to determine if an anomaly in a perishable good was caused by an event that occurred during the cold chain. The aggregated social media data may be analyzed using methods such as text mining and machine learning. The processing social media at 450 may use these methods to look for patterns that emerge from the social media data (such as concentrations of feedback in a geographic area, around a brand or retail chain, or specific food commodity) and the processing social media at 450 may then use this information to identify particular instances during the cold chain distribution system that may have caused the anomaly. For instance, temperature could have spiked slightly at one point during the transportation, which down the line allowed dangerous levels of bacteria growth in the perishable good. By utilizing the social media tracker 60 and processing social media data at 450, cold chain distribution system companies can quickly identify a problem and narrow in on the source.

Referring now specifically to FIG. 2, which illustrates a schematic view of a method 100 of auditing a cold chain distribution system. In the illustrated embodiment, the method for auditing a cold chain distribution system includes collecting, using a receiver 20, at least one perishable good parameter from the cold chain distribution system at 400; transmitting the at least one perishable good parameter to a computing device 30 at 410; comparing, using a standards matching model 42 and the computing device 30, the at least one perishable good parameter to compliance criteria at 420; and transmitting at least one compliance criteria comparison output 600 from the computing device 30 to a database at 430.

As mentioned above there may be a variety of perishable good parameter collection methods 200 including but not limited to at least one sensor 22, at least one supplier database 24, and manual entry 26. These perishable good parameter collection methods 200 feed into the first step of method 100, which is collecting perishable good parameters at 400. Next at 410, the perishable good parameters are transmitted to the computing device 30. Following that, the computing device 30 utilizes a standards matching model 42 to compare the compliance criteria 320 to the perishable parameters at 420. The comparison at 420 results in compliance criteria comparison output 600, which is transmitted to the database 50 at 430. Once stored within the database, the compliance criteria comparison output 600 may be accessed by end users 500 at 602 or the compliance criteria comparison output 600 may be pushed to end users 500 at 604. This method 100 makes auditing both internal 56 and external with the government 52 and customers 54 much easier. The method 100 tracks the entire cold chain process in real time for a streamlined result. Thus, an audit report could be pulled easily.

Further, in yet another illustrated embodiment, social media data is collected at 440. The social media data is then processed and compared against the compliance criteria comparison output 600 at 450 to verify if any perishable good parameters collected at 400 may have contributed to a reaction on social media. Social media may include but is not limited to Facebook, Twitter, Instagram, LinkedIn, Myspace, Google+, and similar networks. In further embodiments, the social media data may be processed using text mining and other machine learning techniques to provide a status of the perishable good when it reaches the end user 500. Analyzing end user 500 feedback from social media can provide useful insights to the condition of the perishable goods just prior to consumption. This ability to collect social media data at 440 and compare it to the compliance criteria comparison output at 450 allows problems in the cold chain distribution system to be identified and managed properly.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A method of auditing a cold chain distribution system, comprising:
collecting, using a receiver, at least one perishable good parameter from the cold chain distribution system;
transmitting the at least one perishable good parameter to a computing device;
comparing, using a standards matching model and the computing device, the at least one perishable good parameter to compliance criteria; and
transmitting at least one compliance criteria comparison output from the computing device to a database.

2. The method of claim 1, wherein collecting further comprises:
monitoring, using at least one sensor, at least one perishable good parameter.

3. The method of claim 1, wherein collecting further comprises:
receiving, at least one perishable good parameter, from at least one supplier database.

4. The method of claim 2, wherein collecting further comprises:
receiving, at least one perishable good parameter, from at least one supplier database.

5. The method of claim 4, wherein collecting further comprises:
manually entering at least one perishable good parameter into the receiver.

6. The method of claim 1, further comprising:
collecting social media data; and
comparing the social media data to the at least one compliance criteria comparison output.

7. The method of claim 2, further comprising:
collecting social media data; and
comparing the social media data to the at least one compliance criteria comparison output.

8. The method of claim 3, further comprising:
collecting social media data; and
comparing the social media data to the at least one compliance criteria comparison output.

9. The method of claim 4, further comprising:
collecting social media data; and
comparing the social media data to the at least one compliance criteria comparison output.

10. The method of claim 5, further comprising:
collecting social media data; and
comparing the social media data to the at least one compliance criteria comparison output.

11. An apparatus for auditing a cold chain distribution system, comprising:
a computing device configured to compare at least one perishable good parameter to compliance criteria using a standards matching model;
a receiver in operative communication with the computing device, wherein the receiver is configured to receive at least one perishable good parameter from the cold chain distribution system and transmit the at least one perishable good parameter to the computing device; and
a database in operative communication with the computing device, wherein the database is configured to receive and store at least one compliance criteria comparison output from the computing device.

12. The apparatus of claim 11, further comprising:
at least one sensor in operative communication with the receiver, wherein the at least one sensor is configured to sense at least one perishable good parameter and communicate the at least one perishable good parameter to the receiver.

13. The apparatus of claim 11, further comprising:
at least one supplier database in operative communication with the receiver, wherein the at least one supplier database is configured communicate the at least one perishable good parameter to the receiver.

14. The apparatus of claim 12, further comprising:
at least one supplier database in operative communication with the receiver, wherein the at least one supplier database is configured communicate the at least one perishable good parameter to the receiver.

15. The apparatus of claim 14, further comprising:
a manual entry of at least one perishable good parameter into the receiver.

16. The apparatus of claim 11, further comprising:
a social media tracker in operative communication with the database, wherein the social media tracker is configured to collect social media data and compare the social media data to the at least one compliance criteria comparison output.

17. The apparatus of claim 12, further comprising:
a social media tracker in operative communication with the database, wherein the social media tracker is configured to collect social media data and compare the social media data to the at least one compliance criteria comparison output.

18. The apparatus of claim 13, further comprising:
a social media tracker in operative communication with the database, wherein the social media tracker is configured to collect social media data and compare the social media data to the at least one compliance criteria comparison output.

19. The apparatus of claim 14, further comprising:
a social media tracker in operative communication with the database, wherein the social media tracker is configured to collect social media data and compare the social media data to the at least one compliance criteria comparison output.

20. The apparatus of claim 15, further comprising:
a social media tracker in operative communication with the database, wherein the social media tracker is configured to collect social media data and compare the social media data to the at least one compliance criteria comparison output.
